(19) United States
(12) Patent Application Publication
(10) Pub. No.: US 2024/0149634 A1
(43) Pub. Date: May 9, 2024

(54) Vehicular Temperature Regulating System and Panel Assembly Including a Touch Panel Configured to be Heated or Cooled within a Passenger Compartment of a Vehicle

(71) Applicant: JVIS-USA, LLC, Shelby Township, MI (US)

(72) Inventors: Darius J. Preisler, Macomb, MI (US); Jason T. Murar, Macomb, MI (US)

(73) Assignee: JVIS-USA, LLC, Shelby Township, MI (US)

(21) Appl. No.: 17/983,627

(22) Filed: Nov. 9, 2022

(51) Int. Cl. B60H 1/00; G06F 3/041

(52) U.S. Cl. CPC B60H 1/00478; B60H 1/00295; G06F 3/041

(57) ABSTRACT

A vehicular temperature regulating system and panel assembly including a touch panel configured to be heated or cooled within a passenger compartment of a vehicle having a support structure are provided. The assembly includes a touch panel made of a substantially rigid or semirigid, thermally conductive, polymeric material. The touch panel is configured to be attached to the support structure. The assembly also includes a thermoelectric heater/cooler including an array of thermoelectric devices in heat transfer relationship with the touch panel and is configured to pump heat when energized by an electrical power source of the vehicle. Heat conductive properties of the polymeric material allow the touch panel to transfer heat either to or from substantially the entire touch surface of the touch panel to heat or cool, respectively, the touch surface via thermal conduction. Thermal comfort of a passenger within the compartment is thereby improved.

### CROSS-REFERENCE TO RELATED APPLICATION

This application is related to U.S. patent application entitled “Vehicular Temperature Regulating System and Panel Assembly for Radiating Heat within a Passenger Compartment of a Vehicle” filed on the same day as this application and having an Attorney Docket No. JVIS 0201 PUS and U.S. patent application entitled “Vehicular Temperature Regulating System and Panel Assembly for Cooling a Passenger Compartment of a Vehicle” also filed on the same day as this application and having Attorney Docket No. JVIS 0203 PUS.

### TECHNICAL FIELD

This invention generally relates to vehicular temperature regulating systems and, in particular, to such systems which have at least one panel assembly including a touch panel configured to be heated or cooled within a passenger compartment of a vehicle.

### OVERVIEW

As described in U.S. Pat. No. 7,195,202, from the field of climatization measuring technology, it is known that thermal comfort (and associated satisfaction with the climatic environment) requires that a person's condition be thermally balanced in that person's thermal environment. The heat produced by the person must be equal to the heat eliminated to the environment. Deviations result in physiological reactions which, within individual tolerance ranges, are increasingly found to be uncomfortable. Thermal discomfort due to too much heat is associated with, for example, perspiration, whereas thermal discomfort due to coldness leads to a rise of the metabolism and increased muscle activity such as, for example, shivering.

Beside the person's activity and the thermal insulation of the person's clothing, the two variables which most influence the person's thermal comfort are related to the person's direct thermal environment, namely:
(1) the velocity, temperature and moisture of the ambient air; and
(2) the temperature of the enclosing surfaces with which the person is exchanging radiation.

The interaction of the air temperature and the radiation temperature of the enclosing surfaces surrounding the person influences the person's thermal feeling to a high degree. Thus, to a certain extent, at low air temperatures, an increased radiation temperature can contribute to a high thermal comfort of the air conditions in an indoor space. On the other hand, low radiation temperatures have to be compensated by a raising of the air temperature. Indoor space climatization measuring technology indicates that these relationships have to be taken into account when rating a thermal environment.

In the case of passenger planes, at travelling altitude, these enclosing surfaces have low surface temperatures because of the low outside temperature, typically of less than −50° C., and the limited possibility of insulation. With the normally used material of the enclosing surfaces, this results in low radiation temperatures. For passengers situated in seats in the direct proximity of these cold surfaces, a radiation cooling will occur which feels uncomfortable, particularly during long-distance flights.

In addition to the different climatic conditions depending on the distance of the seat from the enclosing surfaces, the climatic situation at the seat differs considerably. The large temperature differences of the radiation temperatures lead to an symmetrical climatic environment for the left or right body half, respectively, which is felt to be particularly uncomfortable (“cold-shoulder effect”). Compensation of this unfavorable radiation climate by raising local air temperature is difficult to implement by means of climatization techniques.

Plastic parts such as automotive interior plastic parts must satisfy a wide variety of environmental and safety regulations including the need for such parts to be recyclable. Because of the potentially large volume of automotive vehicles that are produced year after year, automotive interior parts must be produced in a cost-effective fashion without the need for elaborate and costly manufacturing facilities.

In the automotive industry, it is common practice to refer to various surfaces as being A-, B-, or C-surfaces. As used herein, the term “A-surface” refers to an outwardly-facing surface for display in the interior of a motor vehicle. This surface is a very high visibility surface of the vehicle that is most important to the observer or that is most obvious to the direct line of vision. With respect to motor vehicle interiors, examples include dashboards, door panels, instrument panels, steering wheels, head rests, upper seat portions, headliners, load floors and pillar coverings.

The substrate of a molded part may be realized in a laminar fashion and has an essentially plane contour or a three-dimensional contour with convex and concave regions defined by the respective design, as well as, if applicable, one or more openings and recesses. In order to fix the molded parts in the passenger compartment or on the vehicle door and to mount handles, control elements and storage trays on the molded part, the molded part is also equipped with mounting parts that are also referred to as retainers.

The substrate typically consists of plastics or composite materials that contain plastics such as acrylonitrile-butadiene-styrene (ABS) or polypropylene (PP). Fibrous molding materials on the basis of textile fabrics of hemp, sisal, flax, kenaf, and/or wood components such as wood fibers, dust wood, wood chips or paper bound with duroplastic binders are likewise used as material for the substrate. Foamed materials of polyurethane or epoxy resins that, if applicable, are reinforced with natural fibers or glass fibers may also be considered as material for the substrate.

The side of the respective molded part or substrate that faces the vehicle interior is usually referred to as the visible side. In order to provide the visible side with an attractive appearance, the substrate is equipped with one or more decorative elements of a textile material or a plastic film. The plastic films are used for this purpose are usually colored and have a relief-like embossed surface. If applicable, the decorative elements comprise a cushioning layer of a foamed plastic that faces the substrate and provides the molded part with pleasantly soft haptics. The decorative elements are usually laminated onto the substrate or bonded thereto during the manufacturing of the substrate by means of thermoplastic back-injection molding.

On its edge and/or on an installation side that lies opposite of the visible side, the substrate is advantageously equipped with projections, depressions and bores. The projections, depressions and bores serve for non-positively connecting the molded part to sections of the car body such as a car door or the roof of a passenger compartment by means of retaining elements such as clips, pins and screws.

Certain interior components of vehicles have surfaces that are frequently touched by users (“high interaction vehicle surfaces” or “high touch areas”).

The term “facing material” refers to a material used to conceal and/or protect structural and/or functional elements from an observer. Common examples of facing materials include upholstery, carpeting, and wall coverings (including stationary and/or movable wall coverings and cubicle wall coverings). Facing materials typically provide a degree of aesthetic appearance and/or feel, but they may also provide a degree of physical protection to the elements that they conceal. In some applications, it is desirable that the facing material provide properties such as, for example, aesthetic appeal (for example, visual appearance and/or feel) and abrasion resistance. Facing materials are widely used in motor vehicle construction.

Insert molding is a one-shot process in which a pre-made insert is placed in the tool for molten plastic to flow around. With this process, the plastic encapsulates or surrounds the insert in order to integrate it into a larger injection molded part.

Inserts are often metal and, therefore, must be placed in the mold either robotically or manually prior to the injection of the plastic. The combination of plastic and metal allows designers to capitalize on the weight reduction of plastics and the strength of metal. The insert and the plastic, often a rigid plastic, must mechanically bond together in order for the insert to remain embedded in the plastic. Generally, insert molding results in better and more reproduceable encapsulation than other techniques such as heat staking or ultrasonic welding where the plastic part is melted in order to add the insert.

Insert molding is found in a variety of products across a wide range of industries including medical, pharmaceutical, dental, military applications, electrical/electronics, and safety. Insert molding was developed to place threaded inserts in molded components, and to encapsulate the wire-plug connection on electrical cords; however, this technique has evolved to include inserts as intricate as motors and batteries. Some examples of products manufactured by insert molding include metal knives with plastic handles, and plastic parts with protruding metal screws that allow for repeated fastening and unfastening.

Insert molding offers many advantages such as:

Increases Cost-Efficiency: molding an insert directly into the product avoids post-production operations—reducing production time and saving money.

Enhances Strength: this method creates a single molded plastic piece that is typically more durable and robust than if the product were created via secondary assembly.

Improves Cost-Effectiveness Over Metal: the use of plastic in insert molding decreases the part weight and reduces the amount of metal or other more costly materials needed—decreasing the overall product cost.

Increases Design Options: insert molding allows the combination of plastic with metal or other insert materials, increasing the product design options available to OEMs.

U.S. Published Application No. 2002/0121714 discloses a mold that can be utilized to manufacture automobile interior components that satisfy certain safety requirements such as, for example, head impact collision requirements. A honeycomb structure is inserted into an article defining cavity of the mold during an insert molding process. For example, the mold can be used to manufacture automobile interior components such as, for example, a B pillar.

The mold forms a portion of an insert molding apparatus. In this regard, the mold includes first and second mold halves that are movable with respect to each other between open and closed positions. When the mold is in a closed position, the article defining cavity is defined between the mold halves. The shape of the article defining cavity corresponds to the automobile interior component that is to be manufactured. The mold may include a number of heating units that are used to heat the moldable material that is contained in the article defining cavity during portions of the molding process.

The insert molding process used to form automobile interior components includes the following steps: first, a honeycomb structure having a desired shape is provided; second, the honeycomb structure is positioned at a predetermined position on one of the mold halves; this position corresponds to the location on an automobile interior component that is to be manufactured at which the honeycomb structure is to be located; third, a predetermined amount of a thermoplastic resin, elastomer, or like material is injected into the defining cavity; this causes the automobile interior component to be formed around the honeycomb structure; after the insert molding process is completed, the honeycomb structure is integrally bonded to the automobile interior component; finally, the automobile interior component/honeycomb structure assembly is removed from the mold.

The term “overlies” and cognate terms such as “overlying” and the like, when referring to the relationship of one or a first, superjacent layer relative to another or a second, subjacent layer, means that the first layer partially or completely lies over the second layer. The first, superjacent layer overlying the second, subjacent layer may or may not be in contact with the subjacent layer; one or more additional layers may be positioned between respective first and second, or superjacent and subjacent layers.

There are four fundamental modes of heat transfer: thermal radiation, conduction, convection and advection. Thermal radiation is the emission of electromagnetic waves from all matter that has a temperature greater than absolute zero. Thermal radiation reflects the conversion of thermal energy into electromagnetic energy. Thermal energy is the kinetic energy of random movements of atoms and molecules in matter. All matter with a nonzero temperature is composed of particles with kinetic energy. These atoms and molecules are composed of charged particles, i.e., protons and electrons. The kinetic interactions among matter particles result in charge acceleration and dipole oscillation. This results in the electrodynamic generation of coupled electric and magnetic fields, resulting in the emission of photons, radiating energy away from the body. Electromagnetic radiation, including visible light, will propagate indefinitely in vacuum.

In a majority of motor vehicles having on-board IC engines, vehicle cabin climate, including cabin warm-up, is typically accomplished via forced air systems having heat exchangers that utilize waste heat energy produced by the IC engine. Typically, the heat exchangers are coolant-to-air type, with the engine coolant being used to transfer heat energy to the air that is forced into the vehicle cabin. Some conventional powertrain motor vehicles, as well as hybrid and electric vehicles employ electrically powered heaters to provide vehicle cabin warm-up and thermal comfort of vehicle occupants.

Thermal comfort is generally defined as a condition of mind that expresses satisfaction with the thermal environment and is assessed subjectively. The human body will generate and transfer excess heat into the environment. The transfer of heat is proportional to the difference in temperature between the body and its environment. In a cold environment, the body loses a significant amount of heat to the environment, while in a hot environment the body does not transfer much heat. Both the hot and cold scenarios lead to discomfort. Maintaining a satisfactory level of thermal comfort for occupants of enclosures, such as buildings or vehicles, is one of the important goals of heating, ventilation, and air conditioning (HVAC) design engineers.

Most people will feel comfortable at room temperature, a range of temperatures around 20° to 22° C. (68° to 72° F.), but this may vary between individuals and depending on factors such as activity level, clothing, and humidity. Thermal neutrality is maintained when the heat generated by human metabolism is allowed to dissipate, thus maintaining thermal equilibrium with the surroundings. The main factors that influence thermal comfort are those that determine heat gain and loss, namely metabolic rate, clothing, insulation, air temperature, mean radiant temperature, air speed, and relative humidity. Psychological parameters, such as individual expectations, also affect thermal comfort.

U.S. Published Application 2020/0346517 discloses a method of regulating thermal comfort of an occupant of a vehicle cabin using a radiant heating tile powered via an energy storage device to generate thermal energy. The method also includes detecting the occupant's position via a position sensor, detecting the occupant's surface temperature and detecting a temperature of the tile via at least one temperature sensor. The method additionally includes determining, via an electronic controller, a rate of change of the occupant's surface temperature and a difference between the tile temperature and the occupant's surface temperature relative to a predetermined temperature set-point. The method further includes regulating, via the electronic controller, a power input from the energy storage device to the tile in response to the determined rate of change of the surface temperature and the determined difference between the tile temperature and the occupant's surface temperature to thereby regulate the occupant's surface temperature.

U.S. Published Application 2008/0142494 discloses a thermally regulating heater and a heated seat for motor vehicles which is made using these heaters wherein the resulting heated seat provides enhanced temperature control without the need of any temperature control system. The heaters include the use of a polymeric positive temperature coefficient composition that operates at lower trip temperatures than previous polymeric positive temperature coefficient compositions. The polymeric positive temperature coefficient composition has a trip temperature below the heat deflection temperature of the composition such that the polymeric positive temperature coefficient composition heats the heated seat to a temperature closer to the comfort level of an individual using the heated seat. Since the polymeric positive temperature coefficient composition uses plastic materials, the polymeric positive temperature coefficient composition can be formed into different shapes as needed using a molding process, such as injection molding.

U.S. Published Application 2021/0246986 discloses a vehicle steering wheel that includes a core structure, a heater mat surrounding a portion of the core structure to define a heated portion, a gap in the heater mat defining an unheated portion, a cover wrap surrounding the heater mat and having first and second edges stitched together at a seam, and a thermally conductive polymer thermally coupled to the heater mat and extending across the gap below the first and second edges of the cover wrap for conducting thermal energy.

U.S. Published Application 2022/0003244 discloses a radiant panel for use in the cabin of a motor vehicle and which includes a surface layer that is thermally conductive and includes exterior and interior surfaces. A first interior layer is electrically conductive and includes exterior and interior surfaces. The exterior surface of the first interior layer and the interior surface of the surface layer are coupled to one another. A second interior layer includes thermally insulative properties and a first rigidity. The second interior layer includes exterior and interior surfaces. The exterior surface of the second interior layer and the interior surface of the first interior layer are coupled to one another. A third interior layer includes thermally insulative properties and a second rigidity. The third interior layer includes exterior and interior surfaces. The exterior surface of the third interior layer and the interior surface of the second interior layer are coupled to one another. The second rigidity is greater than the first rigidity.

As described in the article entitled “Plastics that Conduct Heat” published Jun. 1, 2001, by Plastics Technology, heat sinks and other heat-removal applications were among the last areas where thermoplastics—inherent thermal insulators—replaced metals. Modifying plastics to improve their thermal conductivity continues to be an area of opportunity for a handful of compounders. They have taken up the challenge of using plastics to solve problems of heat build-up in electronics, appliances, lighting, automotive, and industrial products.

Among the pioneers whose heat-conductive compounds have gone commercial are PolyOne Corp., Cool Polymers, LNP Engineering Plastics, RTP Co., and Ticona Corp. GE Plastics, DuPont, and A. Schulman. See, for example, U.S. Published Applications: 2017/0066954; 2017/0218245; 2017/0227304; 2019/0023819; and 2020/0002521.

Thermally conductive components are generally not considered to be direct drop-in replacements for metals. Instead, they open up a broad range of new opportunities for “thermal management” applications. Parts molded out of this new generation of materials can replace metals and ceramics in some applications, and non-conductive plastics in others. Uses include custom-molded heat sinks on circuit boards, as well as tubing for heat exchangers in appliances, lighting, telecommunications devices, business machines, and industrial equipment used in corrosive environment. Heat sinks often involve plastic overmolded on a metal heat pipe. Lighting applications also include reflectors, laser-diode encapsulation, and fluorescent ballasts. Automotive headlamp reflectors are also contemplated. See, for example, U.S. published application 2019/0024869.

In temperature sensors, like thermistors, thermally conductive plastic encapsulation can help improve the response of the temperature sensor itself. Thermally conductive compounds are also used to encapsulate small motors and motor bobbins. A diesel fuel pump may use a thermally conductive plastic to help keep fuel flowing in sub-freezing temperatures.

More exotic applications may include radiant floor-heating systems, where a thermally conductive film placed between coils could allow water to be run at lower temperatures. Another possibility is molding all-plastic car radiators around contours of the bumper instead of the traditional square box.

The heat-transfer requirements of ever-smaller and more power-hungry electronics have opened the door for this new generation of cooling materials. Whereas unfilled thermoplastics have a thermal conductivity of around 0.2 W/mK (Watts/meter-° Kelvin), most thermally conductive plastic compounds typically have 10 to 50 times higher conductivity (1-10 W/mK). One firm, Cool Polymers, offers products with 100 to 500 times the conductivity of a base polymer (10-100 W/mK).

Traditionally, aluminum has been the prime material for controlling higher heat fluxes in electronics. Thermal conductivity of extrusion-grade aluminum alloys is near 150 W/mK. Some die-cast metal alloys (magnesium or aluminum) are in the 50-100 W/mK range.

However, it can be argued that metals' high thermal conductivity cannot be effectively utilized if they conduct heat to the surface of a product faster than air-flow convection can remove heat from the surface. Heat transfer in many applications is convection-limited (that is, design-dependent), not conduction-limited (material-dependent). In certain applications thermally conductive plastics provide heat transfer equivalent to aluminum and copper designs.

Where conductivity is the limiting factor, metal is the preferred material. But there are many applications where convention is the limiting factor, and then thermally conductive plastics are a better fit.

Also, thermally conductive plastics typically boast lower coefficients of thermal expansion (CTE) than aluminum and can thereby reduce stresses due to differential expansion, since the plastics more closely match the CTE of silicon or ceramics that they contact. Conductive plastics also weigh 40% less than aluminum; they offer design freedom for molded-in functionality and parts consolidation; and they can eliminate costly post-machining operations.

Many technological advances utilizing microelectronics would have been difficult without thermally conductive plastics. This ability to control heat build-up, yet also provide lightweight, flexible, and low-cost applications, make these plastics an important technological development.

Suppliers say the technology has been best suited to high-volume production in order to realize the design and fabrication advantages of injection molding. However, part size can make an important difference. For a small part, the majority of the cost is in the injection molding process, while for larger parts, material is the big factor.

Active Ingredients

Among the most commonly used heat-conductive additives are graphite carbon fibers and ceramics such as aluminum nitride and boron nitride. Graphite fibers conduct electricity as well as heat, which suits them to applications where RFI shielding is required, such as hand-held communication devices. By contrast, the ceramic additives are electrically insulative. They are suited to applications that come into contact with electrical leads. Virtually all the suppliers of thermally conductive compounds offer both electrically conductive and insulative types. Thermally conductive compounds are usually formulated with crystalline engineering resins due to their high heat resistance and lower melt viscosities, but amorphous resins can also be used. Cool Polymers, for instance, has developed a thermally conductive polysulfone compound. In general, conductive compounds have higher stiffness and strength, but lower impact properties than unfilled or glass-reinforced resins. For example, a glass-reinforced nylon 66 has a notched Izod impact of around 1.7-1.8 ft-lb/in., while a thermally conductive, electrically insulative nylon 66 has a notched Izod of 1.0 ft-lb/in.

The most thermally conductive additives are specialty graphite fibers made from petroleum pitch. They have conductivity values of 500-1000 W/mK. By comparison, structural-grade carbon fibers based on polyacrylonitrile (PAN) have conductivities less than 10 W/mk. Thermal conductivity of electrically insulative ceramic fillers are 60-80 W/mK for boron nitride and 300 W/mK for aluminum nitride powders. Most commercial uses of pitch graphite fibers require conductivity in the range of 500 W/mK. This typically requires high fiber loadings. Even at such high loadings, fairly long flow paths are possible with crystalline plastics like LCP and PPS, owing to their excellent interfacial compatibility with graphite fibers. Also pricey are the ceramic fillers. Compounds with aluminum nitride flow much better than those containing boron nitride due to the former filler's rounder particle shape versus the latter's platelet shape. As a result, one can easily get loadings as high as 60% by volume of aluminum nitride, compared with up to 20% by volume for boron nitride.

Advanced Ceramics Corp. has surface treatments that allow boron nitride (BN) to be loaded at high enough levels and maintain good moldability. Progress has been made to modify the BN particle shape and size to optimize thermal conductivity. Another U.S. supplier of boron nitride is Saint-Gobain Advanced Ceramics, formerly called Carborundum Corp.

Graphite fibers and ceramic fillers both can be abrasive to processing equipment. Molders can compensate by using low-compression screws and avoiding small gates and check rings. In general, minimize shear.

The biggest difference in processing these compounds is that they cool very rapidly in the injection mold because they transfer heat very quickly. So once they stop flowing, they won't start flowing again. This is a consideration in mold design, such as where one puts vents and gates.

Polymer Range Expands

Initial work on heat-conducting thermoplastics has focused on highly heat-resistant resins like LCP, PPS, PEEK, and polysulfone. PolyOne also has compounds based on polyetherimide (GE's Ultem). Suppliers have expanded their range to include medium-temperature resins like ABS, PBT, polycarbonate, and nylon, as well as lower-temperature commodity plastics like PP and PS. Even TP elastomers are getting the thermal-conductivity treatment.

In the mid-temperature engineering resins group, there are applications for heat sinks in smaller stepper-motors for a broad range of industrial equipment. In the commodity resins area, there is potential for PP-based compounds and PS in non-electronic applications such as food-related consumer heating and cooling products.

Cool Polymers' CoolPoly line includes compounds of LCP, nylon 66, PC/ABS, and PPS. They offer thermal conductivities up to 60 W/mK, depending on resin type. Elastomeric TPO compounds are also available.

LNP's Konduit line includes PPS, PP, and nylon 6 and 66 grades. These resins are compounded with carbon, ceramic, or metallic fillers and small amounts of glass reinforcements, if needed. A lower-cost product group uses ceramic or metal additives to provide thermal conductivity up to 2 W/mK. A high-performance product group uses a specialty carbon fiber to achieve 10 W/mK.

PolyOne's Therma-Tech line includes compounds of LCP, PPs, and PPA (BP's Amodel) with thermal conductivities up to 10-12 W/mK. Additions include a TPV (flexible crosslinked TPO).

RTP's Thermoplastic Conductive Compound (TCC) line can be custom formulated in PPS, LCP, PPA, PC, nylon 66, PP, PE, and TPEs (olefinic or styrenic). RTP offers conductive compounds for both injection molding and extrusion. An example of the latter is a PP compound used for tubing to convey paints and adhesives that must be kept at a constant temperature.

Ticona offers Fortron PPS grades with thermal conductivities up to 3.0 W/mK in electrically insulative or conductive versions.

Packing more powerful microelectronics into ever smaller spaces would be difficult without heat sinks and heat spreaders molded from thermally conductive thermoplastic compounds.

The following U.S. patents are related to at least one embodiment of the present invention: U.S. Pat. Nos. 4,857,711; 4,777,351; 4,931,627; 6,684,217; 6,150,642; 6,307,188; 6,455,823; 7,202,494; 7,245,504; 7,285,748; 8,544,942; and 9,237,606.

The following U.S. patent documents are also related to at least one embodiment of the present invention: 2010/0258645; 2010/0383356; 7,049,559; 8,884,191; 2011/0163576; 2012/0049586; 2012/0168420; 2012/0228277; 2012/0274104; 2014/0103021; 2015/0110477; 2016/0039265; 2016/0059669; 2016/0200172; 2017/0118861; 2017/0129310; 2017/0144501; 2017/0321902; 2017/0349029; 2019/0357032; 9,873,309; 10,493,822; and U.S. Pat. No. 10,583,713.

### SUMMARY OF EXAMPLE EMBODIMENTS

An object of at least one embodiment of the present invention is to provide a vehicular temperature regulating system and panel assembly including a touch panel configured to be heated or cooled within a passenger compartment of a vehicle.

In carrying out the above object and other objects of at least one embodiment of the present invention, a panel assembly including a touch panel configured to be heated or cooled within a passenger compartment of a vehicle having a support structure is provided. The assembly includes a touch panel made of a substantially rigid or semirigid, thermally conductive, polymeric material. The panel has a front surface and a back surface. The touch panel is configured to be attached to the support structure. The assembly also includes a thermoelectric heater or cooler having an array of thermoelectric devices in heat transfer relationship with the touch panel. The heater or cooler is configured to pump heat when energized by an electrical power source of the vehicle. Heat conductive properties of the polymeric material allow the touch panel to transfer heat either to or from substantially the entire touch surface of the touch panel to heat or cool the touch surface, respectively, via thermal conduction. Thermal comfort of a passenger within the compartment is improved when the touch panel is touched by passenger.

The thermoelectric heater may comprise a heater mat.

The thermoelectric heater or cooler may be thermally coupled to the touch panel in a molding process. The molding process may be an insert molding process.

The polymeric material may be a thermoplastic.

The array of thermoelectric devices may be printed on a flexible substrate.

Each of the thermoelectric devices may comprise conductive ink printed on the flexible substrate.

The touch panel may be electrically nonconductive.

The touch panel may be a plastic molded panel.

The touch panel may be injection molded.

The touch panel may comprise an automotive trim panel.

The touch panel may be concavely formed and the back surface of the substrate panel may define a recess.

The touch panel may be configured to be attached to a pillar of the support structure.

The touch panel may be formed as a unitary molded part from at least one plastic.

The touch panel may be configured to be attached to a door of the support structure.

The touch panel may be configured to be attached to a roof of the support structure.

Each of the thermoelectric devices may include a plurality of Peltier heater/cooler elements configured to pump heat through the panel in response a supply of electricity from the power source.

The thermoelectric heater or cooler may be encapsulated within the touch panel.

The assembly may further comprise a heat-transmissible facing material overlying and in thermal contact with the touch panel. Pumped heat travels through the facing material.

Further in carrying out the above object and other objects of at least one embodiment of the present invention, a vehicular, temperature regulating system is provided including one or more panel assemblies as noted above together with a temperature control circuit.

### BRIEF DESCRIPTION OF THE DRAWINGS

FIG. 1 is an interior, perspective, environmental view, partially broken away, of a passenger compartment of an automotive vehicle in which at least one embodiment of the present invention can be used to heat or cool the passenger compartment of a vehicle and to provide at least one touch panel configured to be heated or cooled;

FIG. 2 is an exploded perspective view of a panel assembly of at least one embodiment of the present invention wherein a substrate panel of the assembly is configured to be attached to a roof of a vehicle support structure;

FIG. 3 is an interior, perspective, environmental view, partially broken away, of a passenger compartment or seating area within an autonomous, ride-share vehicle in which one or more panel assemblies constructed in accordance with at least one embodiment of the present invention can be used to heat or cool the passenger compartment of the vehicle and to provide at least one touch panel configured to be heated or cooled;

FIG. 4 is an interior, perspective, environmental view, partially broken away, of a vehicle interior showing various panel assemblies constructed in accordance with at least one embodiment of the present invention and used to heat or cool panel surfaces including touch panel surfaces, any passengers and air within the vehicle interior; the slotted or dashed lines in FIGS. 1, 3 and 4 represent infrared radiation or radiated heat;

FIG. 5 is a schematic, front elevational view of a two-dimensional array of electrically connected, thermoelectric devices, each of which includes a plurality of resistance heating elements and which populate a thermoelectric heater constructed in accordance with at least one embodiment of the present invention; and

FIG. 6 is a schematic view, partially broken away and in cross-section, of a vehicular temperature regulating system and panel assembly constructed in accordance with at least one embodiment of the present invention together with an injection molding machine which can be used in making the system including the panel assembly via an insert molding process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As used in this application, the term “substrate” or “substrate panel” refers to any flexible, semi-flexible or rigid single or multi-layer component having a surface to which a decorative, heat-transmissible membrane is or can be applied. The substrate may be made of polymers and other plastics, as well as composite materials. Furthermore, the shape of the substrate and, particularly, the surface to be covered can be any part of an assembly or device manufactured by any of various methods, such as, without limitation, conventional molding, extruding, or otherwise fabricated.

The term “overlies” and cognate terms such as “overlying” and the like, when referring to the relationship of one or a first, superjacent layer relative to another or a second, subjacent layer, means that the first layer partially or completely lies over the second layer. The first, superjacent layer overlying the second, subjacent layer may or may not be in contact with the subjacent layer; one or more additional layers may be positioned between respective first and second, or superjacent and subjacent layers.

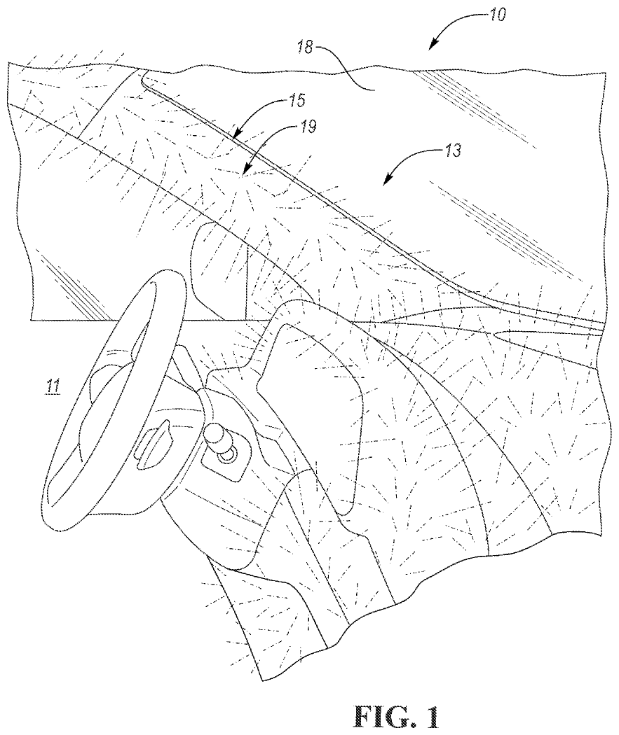

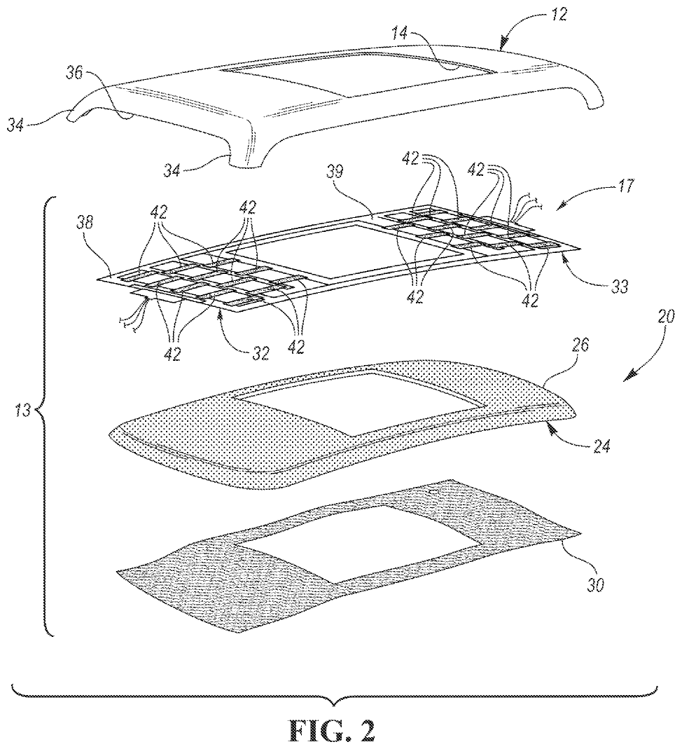

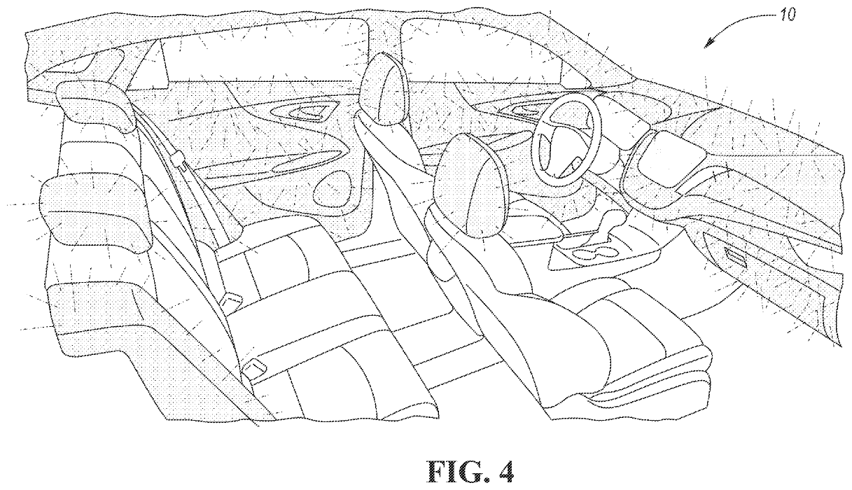

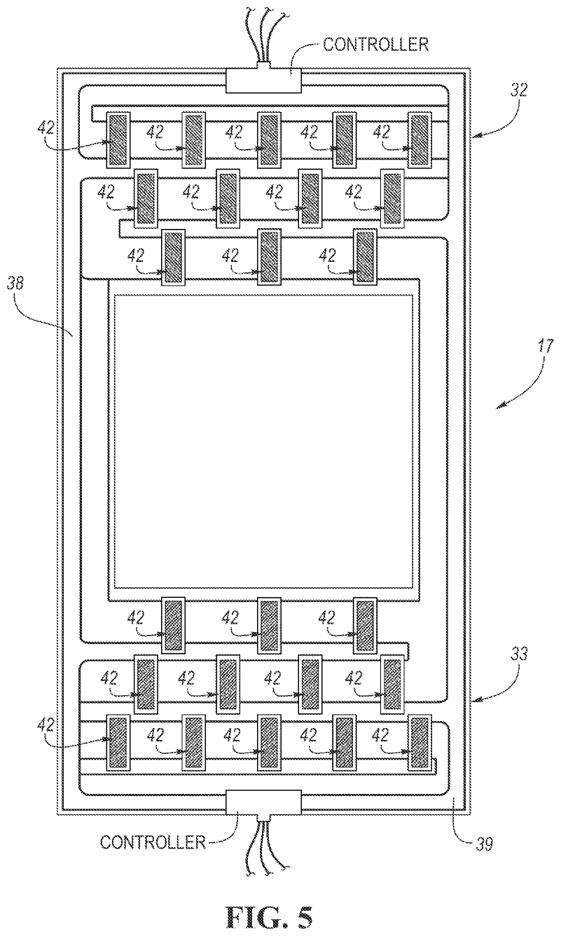

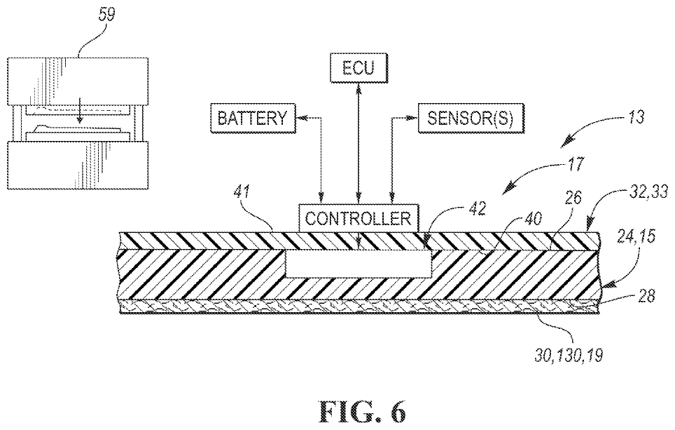

Referring now to the drawing Figures, FIGS. 1 and 4 illustrate a vehicle, generally indicated at 10, in which at least one embodiment of the present invention can be employed with respect to a variety of vehicle interior compartments such as pillars (FIGS. 1 and 2), knee holsters, doors, instrument panels, roofs (FIG. 2), head rests, glove boxes, etc. The interior of the vehicle 10 includes a passenger compartment 11 and pillars 34 (i.e. FIG. 2) of a support structure of the vehicle 10. The vehicle 10 can include a number of sensors such as vehicle occupancy sensors, temperature sensor(s) and a microphone to generate sensor data for use by the vehicle's electronic control unit (ECU) as well as a controller disclosed herein (i.e. FIGS. 5 and 6).

The vehicle 10 is illustrative of any type of automobile or other vehicle in which at least one embodiment of the present invention can be used. For example, the vehicle 10 may include, but is not limited to, a car, a truck, an SUV, a semi-truck, a tractor, a plane, a boat, a train, etc.

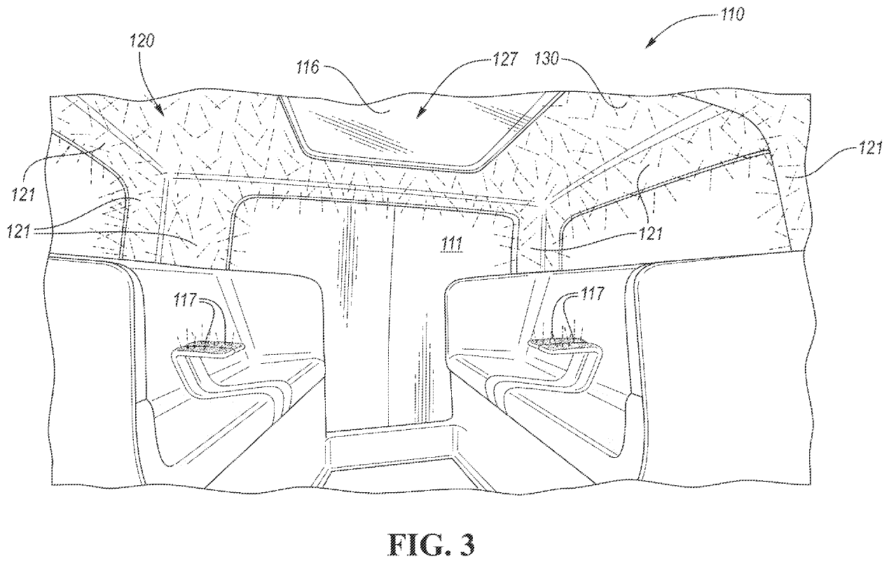

Referring to FIG. 3, an autonomous vehicle 110 includes a roof which forms part of a support structure of the vehicle 110 and covers a passenger compartment 111 in which passengers or occupants of the vehicle 110 ride. Also shown in FIG. 3 are a number of panels 121 which extend downwardly from the roof and a number of elevated touch panels 117 for supporting the arms of seated passengers in the vehicle 110.

The roof 12 of FIG. 2 may include a moonroof opening 14. For purposes of this description, the terms sunroof and moonroof are used interchangeably, such that the moonroof opening 14 may alternatively be referred to as a sunroof opening. A moonroof assembly similar to the moonroof assembly, generally indicated at 127 in FIG. 3, fills the moonroof opening 14 and some of the adjacent structure of the roof 12. The moonroof assembly 127 facilities sliding, tilting, or other movement of a glass or opaque panel 116 that selectively covers the moonroof opening 14.

The roof 12 is bounded by a windshield or windscreen 18 (FIG. 1) at a forward position of the vehicle 10, relative to the direction of travel. Similarly, the roof 12 generally terminates at a similar window or windscreen (not shown) at a rearward potion of the vehicle 10.

The windscreen 18 and the windscreen (not shown) at the rear may be different components in production vehicles.

A panel assembly, indicated at 13 in FIGS. 1, 2 and 6, is configured to heat a vehicle interior within the passenger compartment 11 of the vehicle 10. The assembly 13 includes a substrate panel, generally indicated at 15, and a thermoelectric heater, generally indicated at 17, having a two-dimensional array of thermoelectric devices 42 which are positioned between front and back surfaces of the panel 15 such as by encapsulation (FIG. 6). In the embodiment of FIG. 5, each device 42 comprises a plurality of resistance or resistive heating elements. The panel 15 and the heater 17 may together form any one of the panel assemblies depicted in FIGS. 1-4.

In another embodiment, each panel assembly 13 is configured to either heat or cool the vehicle interior with an array of thermoelectric, Peltier devices 42 as described in greater detail hereinbelow. In this embodiment, the Peltier devices 42 together with a controller (i.e., FIGS. 5 and 6) form a temperature control circuit. The control circuit and panel assembly form a system for regulating temperature within the passenger compartment 11 or 111. Each Peltier device 42 comprises heater/cooler elements which actively provide cooling or heating to the substrate panel 15 as directed by the controller. The Peltier devices 42 add or remove heat from the passenger compartment 11 or 111 via the substrate panel 15 during warming up/cooling down cycles, respectively.

The assembly 13 may include a continuous membrane, generally indicated at 19, 30 and 130 in FIGS. 1, 2 and 3, respectively, of heat-transmissible facing material overlying and in contact with the panel 15. The membrane 19 is typically tightly stretched over the panels 15 and 24 at their front surfaces 28. The membrane is typically porous and heat transmitting. The membrane 19 may be made of a polymer and/or may be naturally porous.

A headliner or panel assembly, generally indicated at 120 in FIG. 3, sits below the roof and includes components providing a functional and an aesthetic barrier between the roof and the passenger compartment 111. The headliner assembly 120 may also be referred to as a headliner or panel assembly.

The headliner 120 is preferably, a lightweight, thermoplastic headliner, constructed in accordance with at least one embodiment of the present invention. The headliner 120 includes a stiff, self-supporting, substrate panel or thermoplastic sheet, generally indicated at 24 in FIG. 6, which is adapted to be mounted adjacent the roof so as to underlie the roof and shield the roof from view. Like the panel 15, the sheet 24 has an upper or back surface or face 26 and a lower or front surface or face 28 (FIG. 6).

The headliner 120, as well as the headliner 20, may be attached to the vehicle roof of the vehicle support structure by double-sided tape or a heat-activated adhesive. Alternatively, the upper surface 26 of the thermoplastic sheet 24 may be provided with integrally formed fasteners (not shown) to fasten the headliner 120, as well as the headliner 20, to complementarily-formed fasteners (not shown) formed on the lower surface of the vehicle roof.

The thermoplastic resin of the thermoplastic sheet 24, as well as the panel 15, may be thermally conductive TPO, ABS, PC/ABS, or polypropylene with a mold-in color. As shown in FIG. 2, the thermoplastic sheet 24 and the panel 15 are stiff and self-supporting, yet the sheet 24 is flexible enough to bend slightly so that the headliner 20 can be inserted between two spaced apart A-pillars 34 of the vehicle roof 12 which help to define a front windshield opening 36. (The panel 15 is configured to be attached to the A-pillars 34). The substrate panel 24 and the panel 15 are dimensionally stable and may be formed from other thermally conductive plastic materials. Typically, these materials are not electrically conductive.

A continuous, porous membrane of heat transmissible facing material or cover stock 30 of the headliner 20 has an A-surface and covers the substrate panel 24 and spans substantially the entire headliner 20 as shown in FIGS. 2 and 6. In like fashion, a similar facing material 130 covers the headliner 120 as shown in FIGS. 2 and 6. The cover 30 overlies and is in contact with the substrate panel 24. The cover 30 is typically tightly stretched over the front surface of the panel 24. The cover stock or cover 30 may be formed by bonding a decorative, textile sheet or fabric to the substrate panel 24 to give the headliner 20 a soft, padded feel. The cover stock 30 may be a single material which is both flexible and has an aesthetically pleasing tactile surface. The cover stock 30 is wrapped, pulled, and adhered over the substrate 24. The cover stock 30 may be compressible and flexible, such that the cover stock 30 may be bent or pulled around tight corners and may have a variable thickness depending upon the assembly process.

As shown in FIGS. 2 and 5, the assembly 20 also includes a forward heating array panel portion, generally indicated at 32, and a rearward heating array panel portion, generally indicated at 33. Each array panel portion 32 or 33 (as well as an array panel (not shown) for use with the panel assembly 13 of FIG. 1) preferably includes one or more printed or non-printed circuits 38 and 39, respectively, each of which is preferably configured to conduct electrical current to an array of semiconductor-based, or carbon-based, thermoelectric devices, generally indicated at 42. The printed circuits 38 and 39 of the panel portions 32 and 33, respectively, not only energizes a plurality of thermoelectric devices 42 at a front face 40 of its panel portion 38 or 39, but may also support the electronic controller on a rear face 41 thereof for controlling the thermoelectric devices 42 (i.e., FIG. 6).

Each of the semiconductor-based, thermoelectric devices 42 may comprise a Peltier device. Each thermoelectric device 42 may contain a plurality of Peltier heater/cooler elements, an integrated circuit (IC) which includes a control circuit having a current driver and signal processing circuitry necessary to control and activate the heating and/or cooling functions of the thermoelectric device 42 by the controller. The controller may include a double pole, double throw (DPDT) electronic switch for reversing polarity of the electric current flowing to the thermoelectric devices 42 for accurate control of the direction and amount of electrical current. In this way, bidirectional heat flow control is achieved.

The thermoelectric devices 42 are typically interconnected by signal traces. Obviously, other types of thermoelectric devices may be used if desired.

The thermoelectric devices 42 may generate or pump heat when energized by the vehicle battery under control of the controller. In this embodiment, the heat conductive properties of the polymeric material of the substrate panel allows the generated heat to be transferred or pumped to the front surface 28 of the panel 24 via thermal conduction. In this way, substantially the entire front surface 28 of the panel 24 is heated. At least some of the transferred heat is then radiated into the passenger compartment 11 of the vehicle 10.

In another embodiment, when the polarity of the electrical current to the semiconductor-based, thermoelectric devices (i.e. Peltier devices 42) is reversed, heat is transferred or pumped from the passenger compartment 11 through the cover 19, from the front surface 28 of the panel 24 to the back surface 26 of the panel and then radiated into the space behind the panel 24. In this way, heat is pumped or transferred from the passenger compartment 11 to cool the passenger compartment 11.

As shown in FIG. 6, the controller is connected to the vehicle's electronic control unit (ECU) via a connector and a vehicle-based bus such as a CAN bus.

The CAN bus typically has lines or conductors for various command or control signals and data to and from the remote control unit (ECU) and the controller. The internal busses typically have lines or conductors for electrical power and command or control data signal to and from the controller and each thermoelectric device 42.

The controller typically includes a power inlet terminal adapted to receive electrical power from a vehicle's 12-volt DC power source and a command input terminal via a first transceiver adapted to receive command signals from the remote electronic control unit (ECU). The controller could be implemented or realized with discrete logic or a microcontroller (i.e. MCU) depending on the system's requirements.

The controller preferably includes the microcontroller including control logic which may alternatively be found within other circuitry. The controller typically receives command signals at its input terminal via the first transceiver from the remote electronic control unit (ECU) over or through the vehicle-based bus (i.e. CAN). Command signals are interpreted by the microcontroller. The microcontroller generates control data signals which, in turn, are received by the control circuits of the thermoelectric devices 42. The microcontroller could be replaced with an FPGA or an extensive array of discrete modules.

An LDO (i.e. low dropout) DC linear voltage regulator may provide regulated voltage to the MCU after initial voltage regulation by a voltage regulator coupled to the terminal which receives the battery voltage.

The remote ECU typically has a microprocessor, called a central processing unit (CPU), in communication with a memory management unit (MMU). The MMU controls the movement of data among the various computer-readable storage media and communicates data to and from the CPU. The computer readable storage media preferably include volatile and nonvolatile storage in read-only memory (ROM), random-access memory (RAM), and keep-alive memory (KAM). For example, KAM may be used to store various operating variables while the CPU is powered down. The computer-readable storage media may be implemented using any of a number of known memory devices such as PROMs (programmable read-only memory), EPROMS (electrically PROM), EEPROMs (electrically erasable PROM), flash memory, or any other electric, magnetic, optical, or combination memory devices capable of storing data, some of which represent executable instructions, used by the CPU in controlling the panel assembly 20 or vehicle into which the panel assembly 20 is mounted.

The computer-readable storage media may also include floppy disks, CD-ROMs, hard disks, and the like. The CPU communicates with various sensors, switches and/or actuators directly or indirectly via an input/output (I/O) and actuators directly or indirectly via an input/output (I/O) interface or vehicle bus (i.e., CAN, LIN, etc.) The interface may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. Some controller architectures do not contain an MMU. If no MMU is employed, the CPU manages data and connects directly to ROM, RAM, and KAM coupled to the MMU or CPU depending upon the particular application.

The various components or functions of the controller of FIG. 6 are preferably implemented by the separate or stand alone controller as illustrated, depending upon the particular application and implementation. The MCU of the controller typically includes the control logic to control the thermoelectric devices 42. The control logic may be implemented in hardware, software, or a combination of hardware and software.

The controller of FIG. 6 comprises power circuitry for powering the thermoelectric devices 42, and the MCU (through the LDO) from the vehicle's 12 VDC power supply. In normal operation, with the vehicle's 12 VDC present, the microcontroller's power will be sourced through the input terminal that receives the vehicle's 12 VDC power.

As will be appreciated by one of ordinary skill in the art, one or more memory devices within the ECU and/or the controller may store a plurality of heating or cooling schemes or algorithms for the thermoelectric devices 42.

Preferably, the control logic is implemented primarily in software executed by a microprocessor-based controller or the microcontroller (i.e. MCU). Of course, the control logic may be implemented in software, hardware, or a combination of software and hardware depending upon the particular application. When implemented in software, the control logic is preferably provided in a computer-readable storage medium having stored data representing instructions executed by the computer of the microcontroller to control the individual thermoelectric devices 42 of the assembly 20. The computer-readable storage medium or media may be any of a number of known physical devices which utilize electric, magnetic and/or optical devices to temporarily or persistently store executable instructions and associated calibration information, operating variables, and the like.

The vehicle bus such as the local interconnect network (LIN) or the CAN bus is capable of two-way communications. A battery voltage power line and a ground line is provided to the controller. The controller typically includes a transceiver interface either within or outside the MCU.

The power sources or supplies of the controller supply electric power of predetermined voltage levels to the MCU and each thermoelectric device 42 on the panel portions 32 and 33 through the LDO and a DC/DC converter, respectively. Each transceiver is a communications interface circuit connected to the network or vehicle bus for communications and operates as a receiver section for the MCU and a transmitter section back to the ECU.

The MCU of the controller typically includes one or more memory circuits and may be configured as a conventional microcomputer including a CPU, a ROM, a RAM, and the like or as a hardwired logic circuit.

The controller may perform data communications regularly through the CAN bus. In such data communications, the controller may transmit static data indicating the state of each thermoelectric device 42 to the ECU.

The following is an example (i.e. taken from U.S. published patent application 2021/0284078) of electronic circuitry within the controller of FIG. 6:

One or more controllers exercise control over all aspects of the system and assemblies of at least one embodiment of the present invention. Each controller may include a central CPU (central processing unit), direct current power supplies, a flash memory device, 2 CAN interfaces, and a set (2) of line level converters. It may also contain a current sensing feature via a current monitoring circuit which detects when the load drops through the DC/DC converter and, informs the microcontroller when this happens. This circuit detects when thermoelectric devices 42 become non-functional and do not draw power from the power supply. The different devices include:

CPU (i.e. microcontroller): an NXP device is used with dual SPI outputs to drive the control data signals sent to the thermoelectric devices 42. The microcontroller internally has flash memory and RAM. It is the central control and monitor of all electronic signals of the system.

Power supply 1: A DC/DC converter is used to supply power to all of the thermoelectric devices 42. It has an input from the vehicle 12-volts power supply. This supply is enabled and monitored by the microcontroller.

Power supply 2. A voltage regulator regulates the voltage from an input to an output. It supplies power to the 2 CAN interfaces, one of the two line level converters, current sense and master select groups of components. This supply is also monitored by the microcontroller.

Power supply 3: This supply has an input from a power supply and regulates an output. This source powers the microcontroller, a memory chip, the second line level converter, and both the CAN interface ports. This supply is also monitored by the microcontroller.

Memory Chip: A flash memory chip is connected directly to the microcontroller. This is utilized to store data files which are used to generate or pump heat by the thermoelectric devices 42.

CAN ports: There are 2 identical CAN ports on the controller. The first port and its transceiver allows the vehicle 10 to exercise control over the controller. The second CAN port with its transceiver is implemented to allow for audio input control signals for the ECU over the CAN to synchronize the heat/cooling intensity levels to sound.

Line level converters: There are two-line level converters. One is used to convert the output from the microcontroller to a level to drive control data signals to the thermoelectric devices 42. The second line level converter converts the voltage of the control data signals from the thermoelectric devices 42 into the microcontroller.

J-Tag Connector. A standard J-Tag connector allows access to the processor of the microcontroller for programming and flashing or strobing purposes.

FIG. 6 illustrates injection molding of the substrate panels 15 and 24 by molding apparatus 59. Preferably, insert molding is used to at least partially encapsulate the thermoelectric devices 42 together within the polymeric material. Alternatively, the thermoelectric devices 42 are screen printed on a polymeric material such as Mylar.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A panel assembly including a touch panel configured to be heated or cooled within a passenger compartment of a vehicle having a support structure, the assembly comprising:
a touch panel made of a substantially rigid or semirigid, thermally conductive, polymeric material, the touch panel having a front touch surface and a back surface and being configured to be attached to the support structure; and
a thermoelectric heater or cooler including an array of thermoelectric devices in heat transfer relationship with the touch panel and configured to pump heat when energized by an electrical power source of the vehicle, wherein heat conductive properties of the polymeric material allow the touch panel to transfer heat either to or from substantially the entire touch surface of the touch panel to heat or cool, respectively, the touch surface via thermal conduction whereby thermal comfort of a passenger within the compartment is improved when the touch panel is touched by the passenger.

2. The assembly as claimed in claim 1, wherein the heater comprises a heater mat.

3. The assembly as claimed in claim 1, wherein the heater or cooler is thermally coupled to the touch panel in a molding process.

4. The assembly as claimed in claim 3, wherein the molding process is an insert molding process

5. The assembly as claimed in claim 4, wherein the polymeric material is a thermoplastic.

6. The assembly as claimed in claim 1, wherein the array of thermoelectric devices are printed on a flexible substrate.

7. The assembly as claimed in claim 6, wherein each of the thermoelectric devices comprises a conductive ink printed on the flexible substrate.

8. The assembly as claimed in claim 1, wherein the touch panel is electrically nonconductive.

9. The assembly as claimed in claim 1, wherein the touch panel is a plastic molded panel.

10. The assembly as claimed in claim 9, wherein the touch panel is injection molded.

11. The assembly as claimed in claim 1, wherein the touch panel comprises an automotive trim panel.

12. The assembly as claimed in claim 1, wherein the touch panel is concavely formed and the back surface of the touch panel defines a recess.

13. The assembly as claimed in claim 1, wherein the touch panel is configured to be attached to a pillar of the support structure.

14. The assembly as claimed in claim 1, wherein the touch panel is formed as a unitary molded part from at least one plastic.

15. The assembly as claimed in claim 1, wherein the touch panel is configured to be attached to a door of the support structure.

16. The assembly as claimed in claim 1, wherein the touch panel is configured to be attached to a roof of the support structure.

17. The assembly as claimed in claim 1, wherein each of the thermoelectric devices includes a plurality of Peltier heater/cooler elements configured to pump heat through the panel in response to a supply of electricity from the power source.

18. The assembly as claimed in claim 1, wherein the thermoelectric heater or cooler is encapsulated within the touch panel.

19. The assembly as claimed in claim 1, further comprising a heat-transmissible facing material overlying and in thermal contact with the touch panel wherein pumped heat travels through the facing material.

20. A vehicular, temperature regulating system for regulating temperature of a touch panel within a passenger compartment of a vehicle having a support structure, the system comprising;
a panel assembly including:
a touch panel made of a substantially rigid or semirigid, thermally conductive, polymeric material, the touch panel having a front touch surface and a back surface and being configured to be attached to the support structure; and
a temperature control circuit including an array thermoelectric devices in thermal contact with the touch panel and configured to pump heat when energized by an electrical power source of the vehicle through the panel and either to the front surface of the panel or to the back surface of the panel to heat or cool the touch surface, respectively, wherein heat conductive properties of the polymeric material allow the touch panel to transfer pumped heat via thermal conduction whereby thermal comfort of a passenger within the compartment is improved when the touch panel is touched by the passenger.

21. The system as claimed in claim 20, wherein the control unit further includes a controller to regulate a power input from the power source to the array of thermoelectric devices.

22. The system as claimed in claim 20, wherein the control circuit is thermally coupled to the touch panel in a molding process.

23. The system as claimed in claim 22, wherein the molding process is an insert molding process and wherein the control circuit is encapsulated within the touch panel.

24. The system as claimed in claim 23, wherein the polymeric material is a thermoplastic.

25. The system as claimed in claim 20, wherein the array of thermoelectric devices are printed on a flexible substrate.

26. The system as claimed in claim 25, wherein each of the thermoelectric devices comprises a conductive ink printed on the flexible substrate.

27. The system as claimed in claim 20, wherein the touch panel is electrically nonconductive.

28. The system as claimed in claim 20, wherein the touch panel is a plastic molded panel.

29. The system as claimed in claim 28, wherein the touch panel is injection molded.

30. The system as claimed in claim 20, wherein the touch panel comprises an automotive trim panel.

31. The system as claimed in claim 20, wherein the touch panel is concavely formed and the back surface of the touch panel defines a recess.

32. The system as claimed in claim 20, wherein the touch panel is configured to be attached to a pillar of the support structure.

33. The system as claimed in claim 20, wherein the touch panel is formed as a unitary molded part from at least one plastic.

34. The system as claimed in claim 20, wherein the touch panel is configured to be attached to a door of the support structure.

35. The system as claimed in claim 20, wherein the touch panel is configured to be attached to a roof of the support structure.

36. The system as claimed in claim 20, wherein each of the thermoelectric devices comprises a plurality of Peltier heater/cooler elements configured to pump heat through the panel in response to a supply of electricity from the power source.

37. The system as claimed in claim 20, wherein the control circuit is partially encapsulated within the touch panel.

38. The system as claimed in claim 20, further comprising a heat-transmissible facing material overlying and in thermal contact with the touch panel wherein pumped heat travels through the facing material.
